(19) United States
(12) Patent Application Publication
(10) Pub. No.: US 2025/0337981 A1
(43) Pub. Date: Oct. 30, 2025

(54) TECHNIQUES FOR SIMULATING A LIVE EDGE IN A LIVE FIELD TEST

(71) Applicant: NETFLIX, INC., Los Gatos, CA (US)

(72) Inventors: Wei WEI, Fremont, CA (US); Christopher Elliott FRY, Los Altos, CA (US)

(21) Appl. No.: 18/649,857

(22) Filed: Apr. 29, 2024

(51) Int. Cl. H04N 21/442; H04N 21/472

(52) U.S. Cl. CPC H04N 21/44209; H04N 21/47202

(57) ABSTRACT

Various embodiments are directed towards a technique for simulating live event streaming on a client device that includes computing a latest available segment number associated with content to be downloaded from a content engine, determining a current segment to be downloaded from the content engine, determining that a segment number associated with the current segment is less than or equal to the latest available segment number, transmitting a request for the current segment to the content engine, and receiving the current segment from the content engine.

### BACKGROUND

### Field of the Various Embodiments

Embodiments of the present disclosure relate generally to streaming media technology and audiovisual content processing and, more specifically, to techniques for simulating a live edge for an item of audiovisual content in a field test.

### DESCRIPTION OF THE RELATED ART

Content service providers, such as streaming video services, may provide audiovisual content to their customers or subscribers via client devices. Client devices may include, without limitation, smartphones, personal computers, television set top devices, or smart TV applications.

In some implementations, a content service provider may transmit a “live event” to various customers or subscribers, where audiovisual content generated from the event is provided to the customers or subscribers in real-time or near real-time as the event occurs. This real-time or near real-time presentation of generated content distinguishes live event content from “Subscriber Video on Demand” (SVOD) content, where the entirety of the SVOD content, e.g., a movie or pre-recorded television episode, is usually previously recorded and prepared for transmission. SVOD content is generally available for viewing via a client device at any time after being recorded and prepared for transmission and sometimes can be viewed repeatedly by a customer or subscriber.

In order to assess the quality of the viewer experience during live events, content service providers oftentimes want to evaluate the performance of different client devices during the transmission and playback of live events. Content service providers typically use measurable criteria, such as latencies, the number of dropped portions of audiovisual content, and/or the number or duration of any buffer underruns, that occur during a live event to evaluate the performance of the different client devices. The content service providers also may want to evaluate any experimental algorithms used by any client devices to process and display the audiovisual content transmitted and received during the live events.

Existing approaches to evaluating the performance of client devices during live events are dependent upon the availability of live event content that can be transmitted to and played back by the client devices. Accordingly, these approaches have several drawbacks. First, the availability of live content for transmission and playback may be limited, both in quantity and duration. For example, system designers or evaluators usually have to wait until the content service provider actually transmits a given live event in order to evaluate client device performance or test experimental algorithms and usually can only do so during the live event. Also, because an event typically can be transmitted live only once, existing approaches do not allow repeated evaluations of client devices over time using the same transmitted content or the evaluation of different experimental algorithms over time using the same transmitted content. Further, designers and evaluators may not want to implement or evaluate experimental algorithms for the different client devices during the transmission of a live event if the content of the live event is important. In this regard, a particular live event may not be suitable for use in evaluating client devices or experimental algorithms if the risks of disrupting or degrading the live event for users outweigh the benefits of evaluating client device and/or experimental algorithms during that live event.

As the foregoing illustrates, what is needed in the art are more effective techniques for evaluating client device performance during live events.

### SUMMARY

One embodiment of the present invention sets forth a technique for simulating live event streaming on a client device. The technique includes computing a latest available segment number associated with content to be downloaded from a content engine, determining a current segment to be downloaded from the content engine, determining that a segment number associated with the current segment is less than or equal to the latest available segment number, transmitting a request for the current segment to the content engine, and receiving the current segment from the content engine.

At least one technical advantage of the disclosed techniques relative to the prior art is that the disclosed techniques enable a live streaming event to be replicated on a client device using SVOD content instead of an actual live event transmission. Accordingly, the disclosed techniques enable repeated evaluation and modification of client devices or experimental algorithms using the same content; something that is not readily achievable with prior art techniques. Further, because the disclosed techniques enable a live event transmission to be simulated using SVOD content instead of an actual live event transmission, there is no risk of interrupting or degrading the playback of a live event when evaluating the performance of a client device or experimental algorithm or modifying the functionality of a client device during a simulated live event. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of the various embodiments.

FIG. 2 is a more detailed illustration of portions of the network infrastructure of FIG. 1, according to various embodiments.

FIG. 3 is a more detailed illustration of client device 130 of FIG. 1, according to various embodiments.

FIG. 4 is a more detailed illustration of localization server 120 of FIG. 1, according to various embodiments.

FIGS. 5A-5B set forth a flow diagram of method steps for performing live edge simulation, according to various embodiments.

FIG. 6 is a flow diagram of method steps for performing content delivery, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

The disclosed techniques include an edge simulation engine that simulates the playback of a live event transmission to a client device using a Subscriber Video on Demand (SVOD) content item rather than a live event transmission. An SVOD content item is an item of audiovisual content that has previously been processed, divided into segments, and stored in its entirety for playback at a client device. Examples of SVOD content items include movies and pre-recorded episodes of a television program. In contrast, live event transmissions are events that are captured, processed, divided into segments, and transmitted to client devices in real-time or near real-time.

The edge simulation engine receives a user request to initiate playback of an SVOD content item or to seek to a specific position within an SVOD content item that is already playing on the client device. In response to the user request, the edge simulation engine repeatedly calculates a latest segment of the content item that should be considered to be available to the client device based on the time of the user request and the time elapsed since the user request. This calculated latest segment of the SVOD content item represents the live edge of a simulated live event transmission. The edge simulation engine transmits a segment request for the calculated segment of the content item to one or more content engines included in one or more localization servers. In response to the segment request, the edge simulation engine receives either the requested segment or an error message from the content engine.

In operation, the edge simulation engine receives a user request via a client device to initiate playback of an SVOD content item at the client device or at a separate display device. Based on a current time at the client device and an initial requested streaming position included in the request, the edge simulation engine generates a segment template. The segment template includes an Availability Start Time (AST) expressed in time units, a start number expressed as a segment number within the SVOD content item, a segment duration expressed in time units, and a timescale expressed in time units. The edge simulation engine transmits the segment template to one or more localization servers.

During playback of the SVOD content item, the edge simulation engine repeatedly transmits segment requests to one or more localization servers for numbered content item segments based on the system time at the client device. The frequency of the segment requests is based on the segment duration such that during steady-state operation, the time between segment requests is equal to the content item segment duration.

A content engine included in a localization server receives the segment request from the edge simulation server and compares the requested segment number to a latest available segment number calculated from the segment template. If the requested segment number is equal to or less than the latest available segment number, the content server transmits the requested segment of the SVOD content item to the edge simulation engine for playback via the client device. If the requested segment of the SVOD content item is not available on the localization server, then the content server requests the content item segment from an upstream localization server or from storage prior to transmitting the content item segment to the live edge simulation engine. If the requested segment number is greater than the calculated latest available segment number, the content server returns an error indication to the edge simulation engine.

One technical advantage of the disclosed techniques relative to the prior art is that the disclosed techniques enable the evaluation and modification of client device live streaming functionality using readily available Subscriber Video on Demand (SVOD) content, rather than requiring a live event transmission. The techniques also enable repeated modification and evaluation of client devices based on the same content item. Furthermore, as the disclosed techniques simulate the transmission of a live event using SVOD content, there is no risk of interrupting or degrading the transmission of a live event while evaluating or modifying client devices. These technical advantages provide one or more technological improvements over prior art approaches.

### System Overview

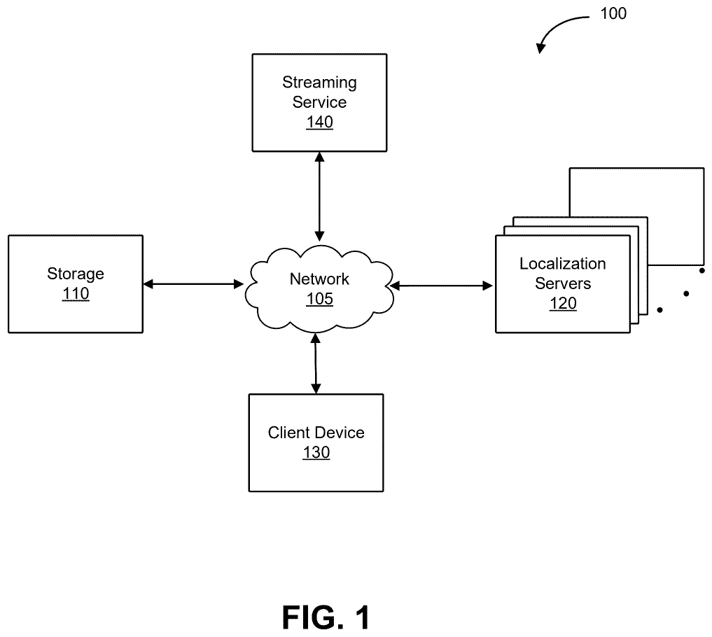

FIG. 1 illustrates a network infrastructure configured to implement one or more aspects of the various embodiments. As shown, network infrastructure 100 includes without limitation a streaming service 140, one or more localization servers 120, cloud storage 110, and a client device 130, which are connected to one another via a communications network 105.

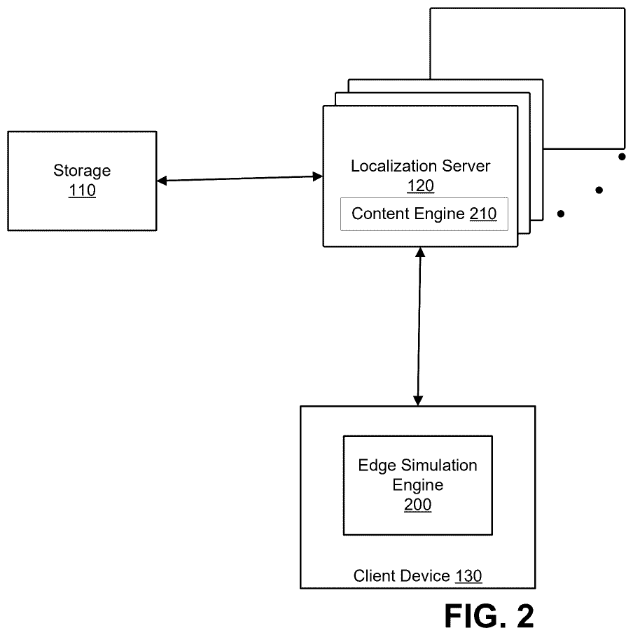

Client device 130 receives a request from a user for playback of a Subscriber Video on Demand (SVOD) content item provided by streaming service 140 discussed below. An SVOD content item is an item of audiovisual content that has previously been processed, divided into segments, and stored in its entirety for later playback via a client device. Examples of SVOD content items include movies and pre-recorded episodes of a television program. In contrast, live event transmissions are events that are captured, processed, divided into segments, and transmitted to client devices in real-time or near real-time. Client device 130 is described in more detail in the description of FIGS. 2, 3, and 5 below.

Streaming service 140 provides items of multimedia content to a variety of users, such as customers or subscribers of the streaming service. As discussed above, Streaming service 140 may provide SVOD content items or live event transmissions to users.

In various embodiments, storage 110 may include file servers, hard disk drives, solid state storage devices, or similar storage devices. Storage 110 may also include an online storage service in which a catalog of files, including thousands or millions of files, is stored and accessed in order to exchange data with the various components in network infrastructure 100. Although not shown in FIG. 1, various embodiments of the present disclosure may implement multiple instances of storage 110. Storage 110 may include content item segments associated with SVOD content items or live event transmissions.

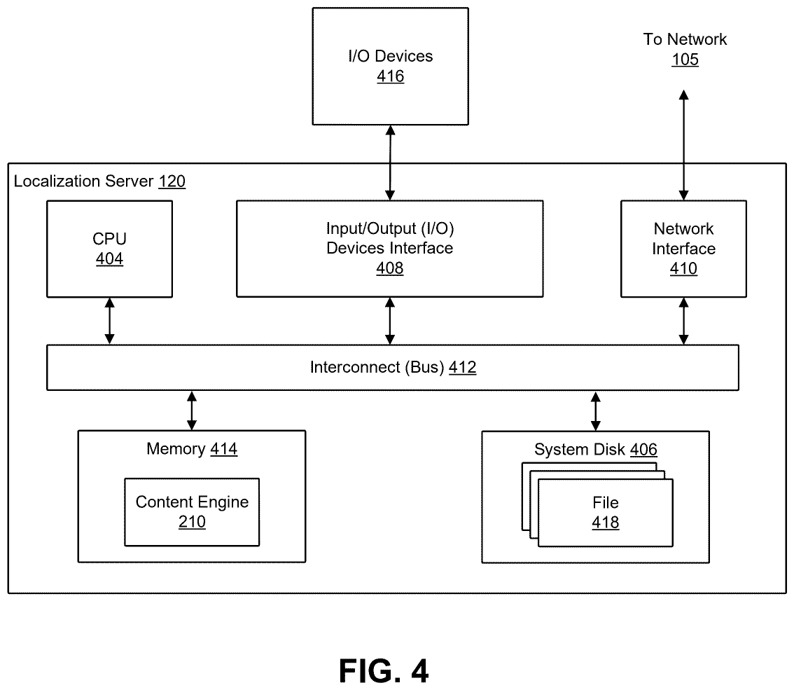

Localization servers 120 store cached copies of content item segments included in storage 110 for transmission to client device 130. Localization servers 120 also receive segment requests for particular segments of a content item from client device 130. Localization servers 120 process the segment requests and either transmit the requested content item segment to client device 130 or generate an error indicating that the requested content item segment is unavailable. Localization servers 120 are discussed in further detail in the description of FIGS. 2 and 4 below.

Network 105 includes any technically feasible wired, optical, wireless, or hybrid network that transmits data between or among streaming service 140, storage 110, localization server(s) 120, client device 130, and/or other components. For example, network 105 could include a wide area network (WAN), local area network (LAN), personal area network (PAN), WiFi network, cellular network, Ethernet network, Bluetooth network, universal serial bus (USB) network, satellite network, and/or the Internet.

### Simulating Live Streaming Using SVOD Content

FIG. 2 is a more detailed illustration of portions of the network infrastructure of FIG. 1 according to various embodiments. As shown, a client device 130 includes edge simulation engine 200 and a localization server 120 includes content engine 210.

Edge simulation engine 200 receives a request from a user via client device 130 for a particular item of SVOD content provided by streaming service 140. Edge simulation engine 200 simulates the transmission of a live event by calculating an availability start time (AST) and a starting segment number for the SVOD content item. Edge simulation engine 200 then sequentially requests content item segments from content engine 210 included in localization servers 120 based on the progression of a current system time associated with client device 130. The content item segments continually received from content engine 210 in response to the sequential requests transmitted by edge simulation engine 200 represent a simulated live event transmission.

A user request for a particular item of SVOD content includes a current system time at client device 130 associated with the request and an initial requested streaming position within the content item expressed as an offset duration from the beginning of the content item. Based on the current system time associated with the request, a predetermined buffer duration, and a predetermined live edge cushion, edge simulation engine 200 calculates an availability start time (AST) in units of system time:

$$A S T = CurrentSystemTime - BufferDuration - LiveEdgeCushion \qquad ( 1 )$$

The combined durations of BufferDuration and LiveEdgeCushion in Equation (1) above represent a period of time beginning at AST for which the corresponding segments of the requested content are considered to be immediately available for retrieval at the client device.

Edge simulation engine 200 also calculates a segment duration in seconds based on a predetermined segment duration expressed in time units and a predetermined timescale expressed in time units per second:

$$SegmentDuration ( seconds ) = SegmentDuration ( units ) / Timescale \qquad ( 2 )$$

For example, according to Equation (2) above, if the predetermined segment duration is 180,000 time units and the predetermined timescale is 90,000 time units per second, the calculated segment duration for each segment of the content item would be (180,000/90,000)=2 seconds.

Edge simulation engine 200 further calculates a starting segment number StartNumber based on the initial requested streaming position within the content item and the calculated segment duration. For example, if the initial requested streaming position in the user request is 120 seconds from the beginning of the content item and the calculated segment duration is 2 seconds, then the starting segment number StartNumber is (120/2)=60.

Edge simulation engine 200 generates a segment template including the AST, the starting segment number, the segment duration expressed in time units, and the timescale expressed in time units per second. Edge simulation engine 200 transmits the segment template to one or more content engines 210 included in one or more localization servers 120. In various embodiments, edge simulation engine 200 may transmit the segment template to content engine 210 included in a localization server 120 via a side channel message. In various other embodiments, edge simulation engine 200 may transmit the segment template to a content engine 210 included in a localization server 120 in a customized HyperText Transfer Protocol (HTTP) request header.

Once the content engine 210 has received the segment template, the edge simulation engine 200 can start requesting segments of the content item from content engine 210. Edge simulation engine 200 first calculates the latest available segment number “lan” using the equation:

$$l a n = floor ( ( CurrentSystemTime - A S T ) / ( SegmentDuration ( units ) / Timescale ) ) + StartNumber \qquad ( 3 )$$

The “floor” function in Equation (3) rounds the calculated Ian value down to the nearest whole integer segment number. This calculated latest available segment number of the content item represents the “live edge” of a simulated live event transmission.

Edge simulation engine 200 then determines whether the segment number for the current segment to be downloaded from content engine 210 is less than or equal to the calculated latest available segment number. For example, initially, edge simulation engine 200 may want to download the starting segment identified by the starting segment number included in the segment template. In such case, edge simulation engine 200 would compare the starting segment number in the segment template to the latest available segment number and determine whether the starting segment number is less than or equal to the latest available segment number. Alternatively, edge simulation engine 200 may want to download a segment having a segment number that is greater than the starting segment number included in the segment template. In such cases, edge simulation engine 200 would compare the segment number of the segment that edge simulation engine 200 wants to download to the latest available segment number and determine whether that segment number is less than or equal to the latest available segment number.

If edge simulation engine 200 determines that the current segment number is less than or equal to the latest available segment number (indicating that the current segment to be downloaded is prior to the “live edge” of the content item), then edge simulation engine 200 transmits a request for the current segment from content engine 210. If, however, edge simulation engine 200 determines that the current segment number is greater than the latest available number (indicating that the current segment to be downloaded is past the “live edge” of the content item and, accordingly, not yet available), then edge simulation engine 200 calculates when the current segment will be available to download, waits that amount of time, and then transmits a request for the current segment from content engine 210.

Content engine 210 receives the request for the current segment of the content item from edge simulation engine 200. Content engine 210 performs the same calculation to determine the latest available segment number Ian as described above, based on data included in the segment template received from edge simulation engine 200 and a current server time as determined by the localization server:

$$l a n = floor ( ( CurrentServerTime - A S T ) / ( SegmentDuration ( units ) / Timescale ) ) + StartNumber \qquad ( 4 )$$

If the segment number of the current segment requested by edge simulation engine 200 is less than or equal to the value of Ian calculated by the localization server, then content engine 210 transmits the requested segment of the content item to edge simulation engine 200 via localization server 120. In various embodiments, content engine 210 may directly transmit a cached copy of the content item segment stored locally on localization server 120 to edge simulation engine 200. If a locally cached copy of the content item segment is not available, content engine 210 may retrieve a copy of the content item segment from an upstream localization server 120 or from storage 110.

If the segment number of the current segment requested by edge simulation engine 200 is greater than the value of Ian calculated by content engine 210, content engine 210 transmits an error, e.g., an HTTP 404 error, to edge simulation engine 200.

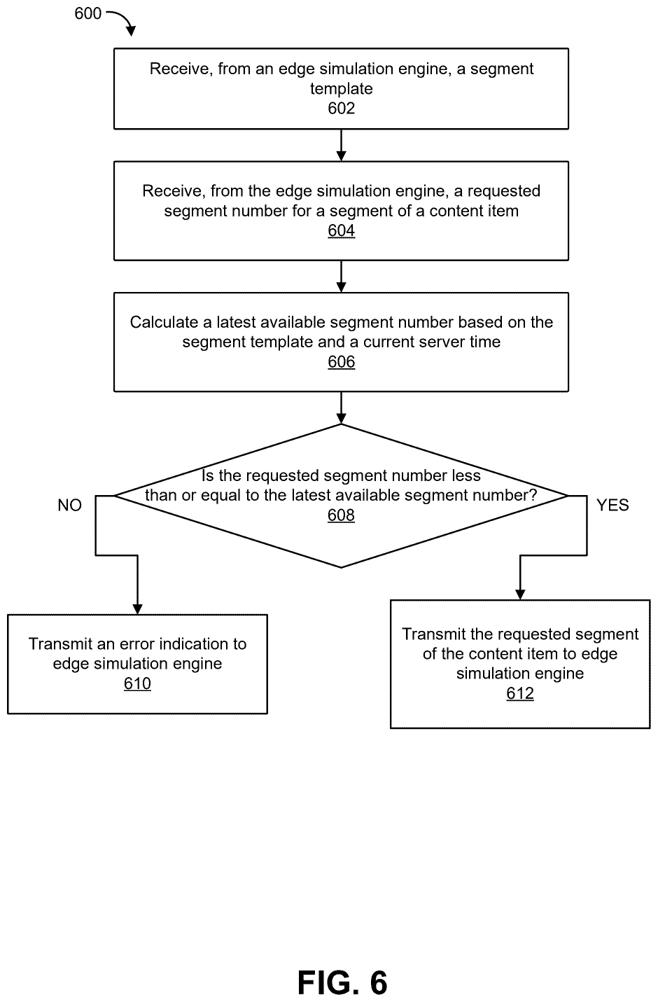

Upon receipt of a content item segment from content engine 210, edge simulation engine 200 may buffer the content item segment for playback on client device 130. As described in greater detail below in conjunction with FIG. 6, in various embodiments, if edge simulation engine 200 receives an error from content server 210, edge simulation engine 200 may execute a trouble shooting or diagnostic technique to identify and address the source of the error.

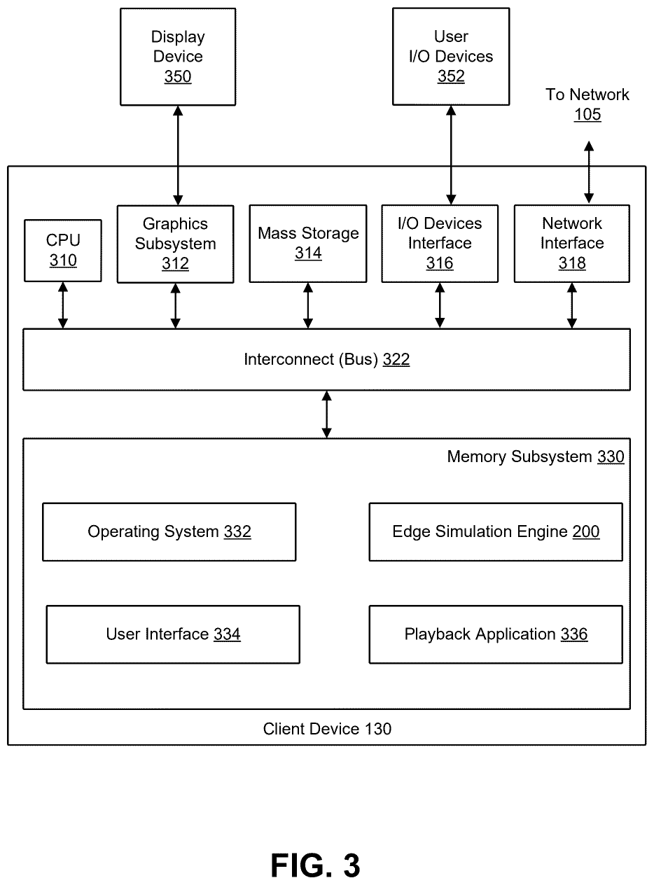

FIG. 3 is a more detailed illustration of client device 130 of FIG. 1 according to various embodiments. As shown, client device 130 may include, without limitation, a CPU 310, a graphics subsystem 312, an I/O devices interface 316, a mass storage unit 314, a network interface 318, an interconnect 322, and a memory subsystem 330.

In some embodiments, CPU 310 is configured to retrieve and execute programming instructions stored in memory subsystem 330. Similarly, CPU 310 is configured to store and retrieve application data (e.g., software libraries) residing in memory subsystem 330. Interconnect 322 is configured to facilitate transmission of data, such as programming instructions and application data, between CPU 310, graphics subsystem 312, I/O devices interface 316, mass storage unit 314, network interface 318, and memory subsystem 330.

In some embodiments, graphics subsystem 312 is configured to generate frames of video data and transmit the frames of video data to display device 350. In some embodiments, graphics subsystem 312 may be integrated into an integrated circuit, along with CPU 310. Display device 350 may comprise any technically feasible means for generating an image for display. For example, display device 350 may be fabricated using liquid crystal display (LCD) technology, cathode-ray technology, and light-emitting diode (LED) display technology. I/O devices interface 316 is configured to receive input data from user I/O devices 352 and transmit the input data to CPU 310 via interconnect 322. For example, user I/O devices 352 may include one or more buttons, a keyboard, and/or a mouse or other pointing device. I/O devices interface 316 also includes an audio output unit configured to generate an electrical audio output signal. User I/O devices 352 includes a speaker configured to generate an acoustic output in response to the electrical audio output signal. In alternative embodiments, display device 350 may include the speaker. Examples of suitable devices known in the art that can display video frames and generate an acoustic output include televisions, smartphones, smartwatches, electronic tablets, and the like.

A mass storage unit 314, such as a hard disk drive or flash memory storage drive, is configured to store non-volatile data. Network interface 318 is configured to transmit and receive packets of data via network 105. In some embodiments, network interface 318 is configured to communicate using the well-known Ethernet standard. Network interface 318 is coupled to CPU 310 via interconnect 322.

In some embodiments, memory subsystem 330 includes programming instructions and application data that include an operating system 332, a user interface 334, a playback application 336, and an edge simulation engine 200. Operating system 332 performs system management functions such as managing hardware devices including network interface 318, mass storage unit 314, I/O devices interface 316, and graphics subsystem 312. Operating system 332 also provides process and memory management models for user interface 334, playback application 336, and/or edge simulation engine 200. User interface 334, such as a window and object metaphor, provides a mechanism for user interaction with client device 130. Persons skilled in the art will recognize the various operating systems and user interfaces that are well-known in the art and suitable for incorporation into client device 130.

In some embodiments, playback application 336 is configured to request and receive content from localization server 120 via network interface 318. Further, playback application 336 is configured to transmit the content to edge simulation engine 200. In response, edge simulation engine 200 causes display device 350 to output frames of video data for playback of the content on client device 130 or on a separate display. In one embodiment, edge simulation engine 200 is included in operating system 332.

FIG. 4 is a more detailed illustration of localization server 120 of FIG. 1 according to various embodiments. As shown, localization server 120 includes, without limitation, a central processing unit (CPU) 404, a system disk 406, an input/output (I/O) devices interface 408, a network interface 410, an interconnect 412, and a system memory 414.

CPU 404 is configured to retrieve and execute programming instructions, such as content engine 210, stored in system memory 414. Similarly, CPU 404 is configured to store application data (e.g., software libraries) and retrieve application data from system memory 414. Interconnect 412 is configured to facilitate transmission of data, such as programming instructions and application data, between CPU 404, system disk 406, I/O devices interface 408, network interface 410, and system memory 414. I/O devices interface 408 is configured to receive input data from I/O devices 416 and transmit the input data to CPU 404 via interconnect 412. For example, I/O devices 416 may include one or more buttons, a keyboard, a mouse, and/or other input devices. I/O devices interface 408 is further configured to receive output data from CPU 404 via interconnect 412 and transmit the output data to I/O devices 416.

System disk 406 may include one or more hard disk drives, solid state storage devices, or similar storage devices. System disk 406 is configured to store non-volatile data such as files 418 (e.g., audio files, video files, subtitle files, application files, software libraries, etc.). Files 418 can then be retrieved by one or more client devices 130 via network 105. In some embodiments, network interface 410 is configured to operate in compliance with the Ethernet standard.

System memory 414 includes content engine 210, which is configured to service requests received from client device 130 and other localization servers 120 for one or more files 418. When server application 417 receives a request for a given file 418, content engine 210 retrieves the requested file 418 from system disk 406 and transmits file 418 to a client device 130 or another localization server 120 via network 105. Files 418 include digital content items such as video files, audio files, and/or still images. In addition, files 418 may include metadata associated with such content items, user/subscriber data, etc. Files 418 that include visual content item metadata and/or user/subscriber data may be employed to facilitate the overall functionality of streaming service 140. In alternative embodiments, some or all of files 418 may instead be stored in storage 110, or in any other technically feasible location within network infrastructure 100.

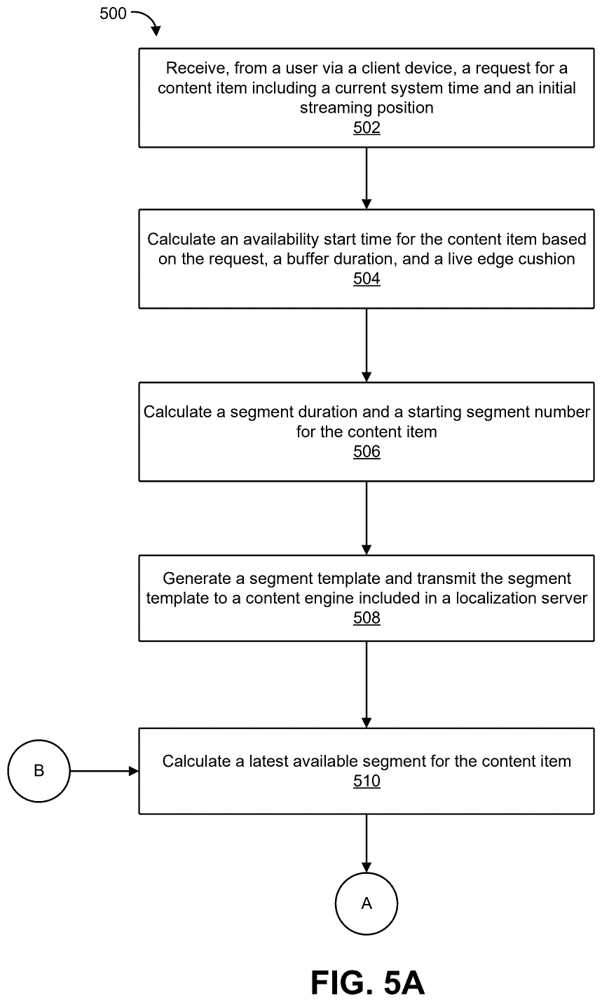

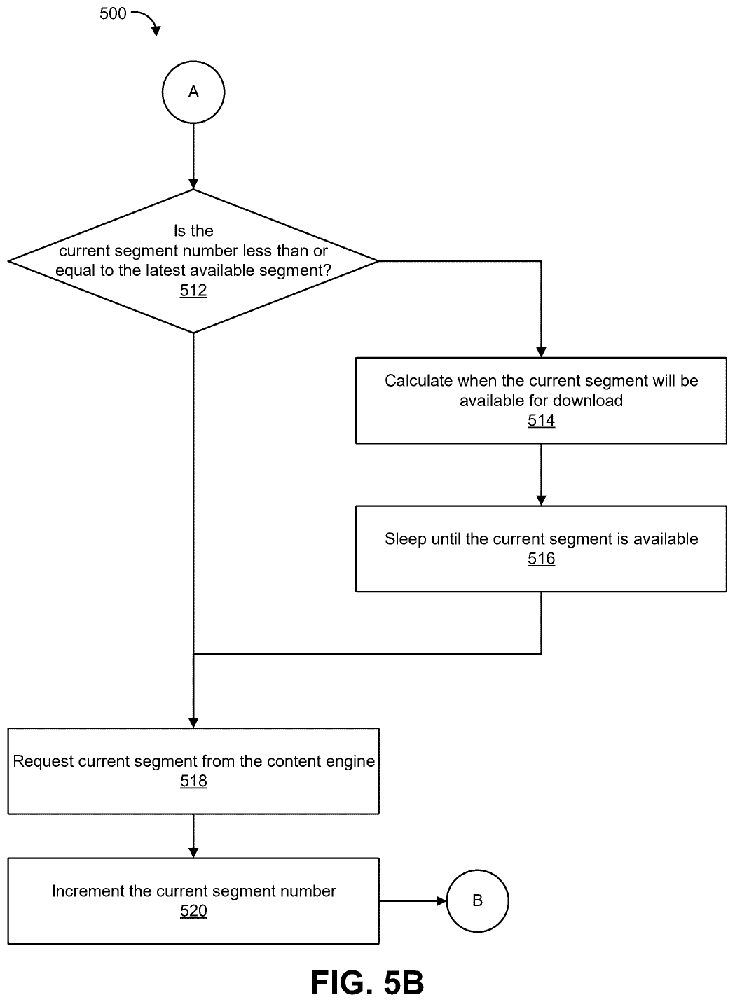

FIGS. 5A-5B set forth a flow diagram of method steps for performing live edge simulation according to various embodiments. Although the method steps are described in conjunction with the systems of FIGS. 1-4, persons skilled in the art will understand that any system configured to perform the method steps, in any order, is within the scope of the present invention.

As shown, method 500 begins at step 502, where edge simulation engine 200 receives a user request via client device 130 for a Subscriber Video on Demand (SVOD) content item. The user request includes a current system time for client device 130 and an initial requested streaming position for the content item.

At step 504, edge simulation engine 200 calculates an availability start time (AST) associated with the content item based on the current system time included in the user request, a predetermined buffer duration, and a predetermined live edge cushion. The combined duration of the buffer duration and the live edge cushion defines a time period beginning from AST for which associated segments of the requested content item are immediately available.

At step 506, edge simulation engine 200 calculates a segment duration for the requested content item based on a predetermined segment duration expressed in time units and a predetermined timescale expressed in time units per second:

$$SegmentDuration ( seconds ) = SegmentDuration ( units ) / Timescale \qquad ( 2 )$$

For example, if the predetermined segment duration is 180,000 time units and the predetermined timescale is 90,000 time units per second, the calculated segment duration for each segment of the content item would be (180,000/90,000)=2 seconds.

Edge simulation engine 200 further calculates a starting segment number StartNumber based on the initial requested streaming position within the content item and the calculated segment duration. For example, if the initial requested streaming position in the user request is 120 seconds from the beginning of the content item and the calculated segment duration is 2 seconds, then the starting segment number StartNumber is (120/2)=60.

At step 508, edge simulation engine 200 generates a segment template for the requested content item. The segment template includes the calculated AST, the calculated starting segment number, the predetermined segment duration and the predetermined timescale. Edge simulation engine 200 transmits the generated segment template to one or more of content server 210 included in one or more of localization servers 120.

At step 510, edge simulation engine 200 calculates a latest available segment number for the requested content item based on a difference between the current system time and the AST, the calculated segment duration, and the starting segment number.

At step 512, edge simulation engine 200 determines whether the segment number for the current segment to be downloaded from content engine(s) 210 is less than or equal to the latest available segment number calculated at step 510. For example, initially, edge simulation engine 200 may want to download the starting segment identified by the starting segment number included in the segment template and transmitted to the one or more content servers at step 508. In such case, edge simulation engine 200 would compare the starting segment number in the segment template to the latest available segment number and determine whether the starting segment number is less than or equal to the latest available segment number. Alternatively, edge simulation engine 200 may want to download a segment having a segment number that is greater than the starting segment number included in the segment template. In such cases, edge simulation engine 200 would compare the segment number of the segment that edge simulation engine 200 wants to download to the latest available segment number and determine whether that segment number is less than or equal to the latest available segment number.

If, at step 512, edge simulation engine 200 determines that the current segment number is less than or equal to the latest available segment number (indicating that the current segment to be downloaded is prior to the “live edge” of the content item being streamed), then the method 500 proceeds to step 518, where edge simulation engine 200 requests the current segment from one or more of content engines 210.

However, if at step 512, edge simulation engine 200 determines that the current segment number is greater than the latest available number (indicating that the current segment to be downloaded is past the “live edge” of the content item being streamed and, accordingly, not yet available), then the method 500 proceeds to step 514, where edge simulation engine calculates when the current segment will be available to download. In one embodiment, edge simulation engine computes a time associated with the latest available segment number and a time associated with the current segment number. For example, the latest available segment number can be mapped to a first time (using equation (3), above, in some embodiments), and the current segment number can be mapped to a second time based on the number of segments between the latest available segment number and the current segment number and the SegmentDuration. The difference between these two computed times is the amount of time that needs to elapse before the current segment is available for downloading. In other embodiments, any other technically feasible technique to determine when the current segment will be available to download may be used.

At step 516, edge simulation engine 200 waits or goes to sleep until the amount of time calculated at step 514 elapses. The/method 500 then proceeds to step 518, where edge simulation engine 200 requests the current segment from one or more content engines 210.

At step 520, edge simulation engine 200 increments the current segment number. The method 500 then returns to steps 510 and 512, where edge simulation engine 200 calculates the latest available segment number for the requested content item and then compares the new current segment number to the newly calculated latest available segment number.

FIG. 6 is a flow diagram of method steps for performing content delivery according to various embodiments. Although the method steps are described in conjunction with the systems of FIGS. 1-4, persons skilled in the art will understand that any system configured to perform the method steps, in any order, is within the scope of the present invention.

As shown, a method 600 begins at step 602, where content engine 210 receives a segment template for an item of subscriber video on demand (SVOD) content from an edge simulation engine 200. The segment template includes an availability start time (AST), a starting segment number, a segment duration expressed in time units, and a timescale expressed in time units per second. In various embodiments, edge simulation engine 200 may transmit the segment template to content engine 210 included in a localization server 120 via a side channel message. In various other embodiments, edge simulation engine 200 may transmit the segment template to a content engine 210 included in a localization server 120 in a customized HyperText Transfer Protocol (HTTP) request header.

At step 604, content engine 210 receives a requested segment number associated with the SVOD content item from an edge simulation engine 200 included in a client device 130. The requested segment number is associated with a specific segment of the SVOD content item.

At step 606, content engine 210 calculates a latest available segment number based on the segment template and a server time associated with a localization server 120 on which content engine 210 resides:

$$l a n = floor ( ( CurrentServerTime - A S T ) / ( SegmentDuration ( units ) / Timescale ) ) + StartNumber \qquad ( 4 )$$

As discussed above, AST, SegmentDuration, TimeScale, and StartNumber are defined in the segment template received from edge simulation engine 200. Equation (4) is identical to Equation (3) described above in the description of FIG. 2, except that Equation (4) includes “CurrentServerTime” determined at the localization server rather than the “CurrentSystemTime” of Equation (3) determined at the client device. The “floor” function in Equation (4) rounds the calculated Ian value down to the nearest whole integer segment number. This calculated latest available segment number of the content item represents the live edge of a simulated live event transmission.

At step 608, content engine 210 compares the calculated latest available segment number Ian to the requested segment number received from edge simulation engine 200 in step 604. If the requested segment number is less than or equal to the latest available segment number, content engine 210 determines that the segment of the content item associated with the requested segment number is available for transmission to edge simulation engine 200, and the method 600 proceeds to step 612.

If, however, the requested segment number is greater than the latest available segment number, then the method 600 proceeds to step 610, where content engine 210 transmits an error message to edge simulation engine 200. In cases where the requested segment number is greater than the latest available segment number, there can be a technical issue causing the clock within client device 130 to become unsynchronized with the clock within localization server 120. In such cases, upon receiving the error message from content engine 210, edge simulation engine 200 and/or client device 130 can execute any type of conventional trouble shooting or diagnostic technique to identify and address the cause of the synchronization issue. In other cases, the fact that the requested segment number is greater than the latest available segment number is indicative of a “rogue” client device 130 that may be trying to “spoof” content engine 210 and/or localization server 120. In such cases, the error message continues to be transmitted to edge simulation engine 200 without the requested current segment each time a request is received for a segment having a segment number greater than the latest available segment number.

At step 612, content engine 210 transmits the segment of the content item associated with the requested segment number to the requesting edge simulation engine 200. In various embodiments, content engine 210 may determine if the segment of the content item is stored locally on the localization server 120 where the content engine resides. If the segment of the content item is stored locally, content engine 210 transmits the segment to the requesting edge simulation engine 200. If the segment of the content item is not stored locally on the localization server 120 where the content engine resides, content engine 210 may request and receive the segment of the content item from a different content engine 210 or from storage such as storage 110. After receiving the segment of the content item, content engine 210 transmits the segment of the content item to the requesting edge simulation engine 200.

After step 610 or 612, method 600 may return to step 602 or step 604 to receive either an additional segment template or an additional requested segment number from an edge simulation engine 200, respectively.

In sum, the disclosed techniques include an edge simulation engine that simulates the transmission of a live event to a client device using a Subscriber Video on Demand (SVOD) content item rather than a live event transmission. An SVOD content item is an item of audiovisual content that has previously been processed, divided into segments, and stored in its entirety for playback at a client device. Examples of SVOD content items include movies and pre-recorded episodes of a television program. In contrast, live event transmissions are events that are captured, processed, divided into segments, and transmitted to client devices in real-time or near real-time.

The edge simulation engine receives a user request to initiate playback of an SVOD content item or to seek to a specific position within an SVOD content item that is already playing on the client device. In response to the user request, the edge simulation engine repeatedly calculates a latest segment of the content item that should be available to the client device based on the time of the user request and the time elapsed since the user request. This calculated latest segment of the SVOD content item represents the live edge of a simulated live event transmission. The live edge simulation engine transmits a segment request for the calculated segment of the content item to one or more content engines included in one or more localization servers. In response to the segment request, the live edge simulation engine receives either the requested segment or an error message from the content engine.

In operation, the edge simulation engine receives a user request via a client device to initiate playback of an SVOD content item or to seek to a specific position within an SVOD content item that is already playing on the client device. Based on a current time at the client device and an initial streaming position included in the request, the live edge simulation engine generates a segment template. The segment template includes an Availability Start Time (AST) expressed in time units, a start number expressed as a segment number within the SVOD content item, a segment duration expressed in time units, and a timescale expressed in time units. The edge simulation engine transmits the segment template to one or more localization servers.

During playback of the SVOD content item, the edge simulation engine repeatedly transmits segment requests to the localization server for numbered content item segments based on the system time at the client device. The frequency of the segment requests is based on the segment duration, such that the time between segment requests is equal to the segment duration.

A content engine included in a localization server receives the segment request from the edge simulation server and compares the requested segment number to a latest available segment number calculated by the content engine from the segment template. If the requested segment number is equal to or less than the latest available segment number, the content engine transmits the requested segment of the SVOD content item to the edge simulation engine for playback via the client device. If the requested segment of the SVOD content item is not available on the localization server, the content engine requests the content item segment from an upstream localization server or from cloud storage prior to transmitting the content item segment to the edge simulation engine. If the requested segment number is greater than the calculated latest available segment number, the content engine returns an error indication to the edge simulation engine.

At least one technical advantage of the disclosed techniques relative to the prior art is that the disclosed techniques enable the evaluation and modification of client device live streaming functionality using readily available Subscriber Video on Demand (SVOD) content, rather than requiring a live event transmission. The techniques also enable repeated modification and evaluation of client devices based on the same content item. Furthermore, as the disclosed techniques simulate the transmission of a live event using SVOD content, there is no risk of interrupting or degrading the transmission of a live event while evaluating or modifying client devices. These technical advantages provide one or more technological improvements over prior art approaches.

1. In one embodiment, a computer-implemented method for simulating live event streaming on a client device comprises computing a latest available segment number associated with content to be downloaded from a content engine; determining a current segment to be downloaded from the content engine; determining that a segment number associated with the current segment is less than or equal to the latest available segment number; transmitting a request for the current segment to the content engine; and receiving the current segment from the content engine.

2. The computer-implemented method of clause 1, further comprising incrementing the current segment, recomputing the latest available segment number, and determining whether a current segment number associated with the incremented current segment is less than or equal to the recomputed latest available segment number.

3. The computer-implemented method of either clause 1 or clause 2, further comprising generating a segment template that includes an availability start time associated with the content item, and transmitting the segment template to the content engine.

4. The computer-implemented method of any of clause 1-3, wherein the availability start time is based on a buffer duration.

5. The computer-implemented method of any of clauses 1-4, wherein the latest available segment number is computed based on the availability start time included in the segment template and a current time associated with the client device.

6. The computer-implemented method of any of clause 1-5, wherein the segment template includes a starting segment number for the content item from which streaming is to begin.

7. The computer-implemented method of any of clauses 1-6, wherein, upon receiving the request for the current segment, the content engine determines that the segment number associated with the current segment is less than or to a second latest available segment number computed by the content server, and, in response, transmits the current segment to the client device.

8. The computer-implemented method of any of clauses 1-7, wherein the second latest available segment number is computed based on the segment template and a current time associated with a localization server on which the content engine resides.

9. The computer-implemented method of any of clauses 1-8, further comprising calculating a segment duration for each segment included in the content item based on a predetermined segment duration expressed in time units and a predetermined timescale expressed in time units per second.

10. The computer-implemented method of any of clauses 1-9, wherein the request includes a current system time associated with the client device and an initial position within the content item from which streaming is to begin.

11. In one embodiment, one or more non-transitory computer-readable media storing instructions that, when executed by one or more processors, cause the one or more processors to perform the steps of computing a latest available segment number associated with content to be downloaded from a content engine; determining a current segment to be downloaded from the content engine; determining that a segment number associated with the current segment is less than or equal to the latest available segment; transmitting a request for the current segment to the content engine; and receiving the current segment from the content engine.

12. The one or more non-transitory computer-readable media of clause 11, further comprising incrementing the current segment, recomputing the latest available segment number, and determining whether a current segment number associated with the incremented current segment is less than or equal to the recomputed latest available segment number.

13. The one or more non-transitory computer-readable media of either clause 11 or clause 12, wherein the current segment number associated with the incremented current segment is greater than the recomputed latest available segment number, and further comprising calculating when the incremented current segment is going to be available for download.

14. The one or more non-transitory computer-readable media of any of clauses 11-13, further comprising waiting until the incremented current segment is available for download, and transmitting a request for the incremented current segment to the content engine.

15. The one or more non-transitory computer-readable media of any of clauses 11-14, wherein the latest available segment number is computed based on an availability start time included in a segment template and a current time associated with the client device.

16. The one or more non-transitory computer-readable media of any of clauses 11-15, wherein the segment template includes a starting segment number for the content item from which streaming is to begin.

17. The one or more non-transitory computer-readable media of any of clauses 11-16, wherein the availability time is based on a buffer duration.

18. The one or more non-transitory computer-readable media of any of clauses 11-17, further comprising transmitting the segment template to the content engine via at least one of a side channel message or a customized HyperText Transfer Protocol (HTTP) request header.

19. The one or more non-transitory computer-readable media of any of clauses 11-18, wherein the content item comprises Subscriber Video on Demand (SVOD) content.

20. In one embodiment, a system comprises one or more memories storing instructions; and one or more processors for executing the instructions to compute a latest available segment number associated with content to be downloaded from a content engine; determine a current segment to be downloaded from the content engine; determine that a segment number associated with the current segment is less than or equal to the latest available segment; transmit a request for the current segment to the content engine; and receive the current segment from the content engine.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for simulating live event streaming on a client device, the method comprising:
computing a latest available segment number associated with content to be downloaded from a content engine;
determining a current segment to be downloaded from the content engine
determining that a segment number associated with the current segment is less than or equal to the latest available segment number;
transmitting a request for the current segment to the content engine; and
receiving the current segment from the content engine.

2. The computer-implemented method of claim 1, further comprising incrementing the current segment, recomputing the latest available segment number, and determining whether a current segment number associated with the incremented current segment is less than or equal to the recomputed latest available segment number.

3. The computer-implemented method of claim 1, further comprising generating a segment template that includes an availability start time associated with the content item, and transmitting the segment template to the content engine.

4. The computer-implemented method of claim 3, wherein the availability start time is based on a buffer duration.

5. The computer-implemented method of claim 3, wherein the latest available segment number is computed based on the availability start time included in the segment template and a current time associated with the client device.

6. The computer-implemented method of claim 3, wherein the segment template includes a starting segment number for the content item from which streaming is to begin.

7. The computer-implemented method of claim 3, wherein, upon receiving the request for the current segment, the content engine determines that the segment number associated with the current segment is less than or to a second latest available segment number computed by the content server, and, in response, transmits the current segment to the client device.

8. The computer-implemented method of claim 7, wherein the second latest available segment number is computed based on the segment template and a current time associated with a localization server on which the content engine resides.

9. The computer-implemented method of claim 1, further comprising calculating a segment duration for each segment included in the content item based on a predetermined segment duration expressed in time units and a predetermined timescale expressed in time units per second.

10. The computer-implemented method of claim 1, wherein the request includes a current system time associated with the client device and an initial position within the content item from which streaming is to begin.

11. One or more non-transitory computer-readable media storing instructions that, when executed by one or more processors, cause the one or more processors to perform the steps of:
computing a latest available segment number associated with content to be downloaded from a content engine;
determining a current segment to be downloaded from the content engine
determining that a segment number associated with the current segment is less than or equal to the latest available segment;
transmitting a request for the current segment to the content engine; and
receiving the current segment from the content engine.

12. The one or more non-transitory computer-readable media of claim 11, further comprising incrementing the current segment, recomputing the latest available segment number, and determining whether a current segment number associated with the incremented current segment is less than or equal to the recomputed latest available segment number.

13. The one or more non-transitory computer-readable media of claim 12, wherein the current segment number associated with the incremented current segment is greater than the recomputed latest available segment number, and further comprising calculating when the incremented current segment is going to be available for download.

14. The one or more non-transitory computer-readable media of claim 13, further comprising waiting until the incremented current segment is available for download, and transmitting a request for the incremented current segment to the content engine.

15. The one or more non-transitory computer-readable media of claim 11, wherein the latest available segment number is computed based on an availability start time included in a segment template and a current time associated with the client device.

16. The one or more non-transitory computer-readable media of claim 15, wherein the segment template includes a starting segment number for the content item from which streaming is to begin.

17. The one or more non-transitory computer-readable media of claim 15, wherein the availability time is based on a buffer duration.

18. The one or more non-transitory computer-readable media of claim 15, further comprising transmitting the segment template to the content engine via at least one of a side channel message or a customized HyperText Transfer Protocol (HTTP) request header.

19. The one or more non-transitory computer-readable media of claim 11, wherein the content item comprises Subscriber Video on Demand (SVOD) content.

20. A system comprising:
one or more memories storing instructions; and
one or more processors for executing the instructions to:
compute a latest available segment number associated with content to be downloaded from a content engine;
determine a current segment to be downloaded from the content engine
determine that a segment number associated with the current segment is less than or equal to the latest available segment;
transmit a request for the current segment to the content engine; and
receive the current segment from the content engine.
